(19) United States
(12) Patent Application Publication
(10) Pub. No.: US 2004/0013813 A1
(43) Pub. Date: Jan. 22, 2004

(54) Materials and method for producing a corrosion and abrasion-resistant layer by thermal spraying

(76) Inventor: Erich Lugscheider, Aachen (DE)

Correspondence Address: BACHMAN & LAPOINTE, P.C., 900 CHAPEL STREET, SUITE 1201, NEW HAVEN, CT, 06510, US

(21) Appl. No.: 10/296,575

(22) PCT Filed: May 18, 2001
(86) PCT No.: PCT/EP01/05733

(30) Foreign Application Priority Data
May 23, 2000 (DE) 100 25 161.7

(51) Int. Cl. B05D 1/08

(52) U.S. Cl. 427/446

(57) ABSTRACT

The invention relates to a method for producing a corrosion and abrasion resistant layer on a substrate by flame spraying, in particular by atmospheric or vacuum plasma spraying, high-power plasma spraying, or shroud plasma spraying of a material based on iron oxide, which consists of pure Fe₂O₃. According to said method, the application of the layer of the material is monitored by an online control and monitoring system.

The invention concerns a process for producing a hard-wearing layer by flame spraying, in particular by flame spraying of a powder and metal oxide.

JP 591 40 363 discloses such a process with which a powder layer of metal oxides such as Al₂O₃, SiO₂, TiO₂, ZrO₂, Na₂O, Cr₂O₃, CaO, Fe₂O₃, V₂O or metal carbides such as WC, TiC, TaC, SiC, Cr₃C or with metal nitrides such as TiN, CrN, TaN, or WN is to be produced.

U.S. Pat. No. 5,912,471 describes an additional device for a coating apparatus having a plurality of sensors and/or optical elements.

DE 34 35 748 A1 depicts the use of a laser anemometer whose measurement volume is adjustable relative to a hot gas jet for ascertaining the particle speeds in the thermal spraying operation. The particle stream density is ascertained by a particle counter which counts the number of spray particles respectively flying through the measurement volume. The mean particle trajectories and the melt condition are calculated in a device for digital data processing.

DE 198 37 400 C1 discloses a process for coating high-temperature components by means of plasma spraying in which the distribution of the thermal radiation of the component surface is ascertained with an infrared camera and determined therefrom is the temperature distribution, in accordance with which a process parameter is adjusted for achieving a threshold temperature.

Tests were carried out to produce protection from wear and corrosion by means of layers applied by a thermal spray process, consisting of iron oxide. It was found in all tests of that nature that the quality of the respective layer could be ensured to some degree, in regard to the layer structure, only at a high level of complication and expenditure.

In consideration of those factors the inventor set himself the aim of improving the production of a constant wear- and corrosion-resistant surface coating on an oxide base, by means of thermal spraying.

That object is attained by the teachings of the independent claims; the appendant claims set forth advantageous developments. In addition the scope of the invention embraces all combinations of at least two of the features disclosed in the description, the drawing and/or the claims.

In accordance with the invention, all thermal spraying processes such as autogenous flame spraying, high velocity flame spraying (HVOF spraying), plasma spraying in air (APS), shroud plasma spraying (SPS), vacuum spraying (LPPS), high-power plasma spraying (HPPS), autogenous wire spraying and arc wire spraying can be used for applying the wear- and/or corrosion-resistant layer.

Online monitoring and control is effected with a combination of various processes which make it possible to measure the temperature of the particle or the degree of melting, the particle size, the speed, the impingement thereof on the substrate and the heating of the layer and the substrate, during the spraying operation. The measurement signals are then passed to the computer of a control installation for the spraying installation and the flame parameters and the output power are matched to the values.

The inventor therefore found that it is possible to produce a coating which satisfies the above-mentioned demands if the material used is an iron-based oxide to which metals, hard substances or intermetallic compounds are added—in dependence on the corrosion or wear problem to be resolved. The material must be produced in accordance with a given production process; in accordance with the invention a powder grain produced from the powder material mixture by spray drying and having good flow properties is proposed, together with a powder grain which is produced from the material mixture in powder form by means of an agglomeration process and which is resistant to separation of the constituents of the mixture.

The spraying installation is equipped with an online monitoring or control system for monitoring purposes in order to be able to produce layers with a high quality and with uniform properties by spraying thereof.

For that purpose an online monitoring and control system by means of an ITG camera directed on to the spray jet, an LDA detector with an LDA laser and an HSP head has proven to be desirable, or online monitoring by means of an ITG camera directed on to the spray jet and an HSP head of a measuring body.

Desirably the particle speed in the spray flame is to be measured by the online monitoring and control arrangement, for example by means of a laser Doppler anemometer, on the basis of a beam which is emitted from a laser device and which is broken down into two beam portions by a transmission optical system.

In accordance with another feature of the invention the particle temperature in the spray flame is observed by the online monitoring and control system, by means of a high-speed pyrometer. That is effected for example by means of infrared thermography.

It has also proven to be desirable to measure the amount of gas, for example an amount of plasma gas, by the online monitoring and control arrangement.

Thanks to the online monitoring and control arrangement it is also possible to evaluate a measured current-voltage characteristic or to measure an amount of powder which is fed to the spray flame.

It is in accordance with the process of the invention that the layer material for production of the corrosion- and wear-resistant layer has pure Fe₂O₃.

More specifically, pure iron oxide Fe₂O₃ with and without metallic materials and/or metallic compounds has proven itself to be particularly advantageous as the layer material. The layers produced under online control exhibited substantially better stability with excellent properties, in comparison with the known layers.

In addition a material with an addition of carbide(s) or nitride(s) or silicide(s) or boride(s) or oxide(s) has proven to be desirable or a material whose additives are mixtures of metals, intermetallic compounds, carbides, nitrides, suicides, borides and/or oxides.

The additions of up to 50% by weight and preferably up to 40% by weight to the material can be for example Cr, CrNi or ferritic steels.

In regard to the hard substances carbides, nitrides, suicides, borides and oxides have proven their worth as additives. In regard to the carbides carbide-forming agents are suitable such as tungsten, chromium molybdenum, niobium, tantalum, titanium, vanadium or the like. The addition of the carbides should be limited to at most 30% by weight—preferably 20% by weight. With the borides and nitrides as additives at that level improvements in the properties were found. Oxidic additions of chromium oxide (Cr₂O₃) of an order of magnitude of between 1 and 40% by weight—preferably between 5 and 30% by weight—also exhibited good results.

In order to achieve a high quality the spray materials in powder form must be of a grain size of between 0.05 and 150 μm—preferably between 0.1 and 120 μm. In regard to the mixtures of various materials in powder form, in order to avoid the mixtures from separating and in order to improve the flow characteristics, it is recommended that they are agglomerated or spray-dried.

When using spray materials in wire form with a high proportion of iron oxide a filling wire can be produced in accordance with the invention comprising a metallic sheath and iron oxide powder.

Further advantages, features and details of the invention will be apparent from the description hereinafter of preferred embodiments and with reference to the respective diagrammatic Figures of the drawing in which:

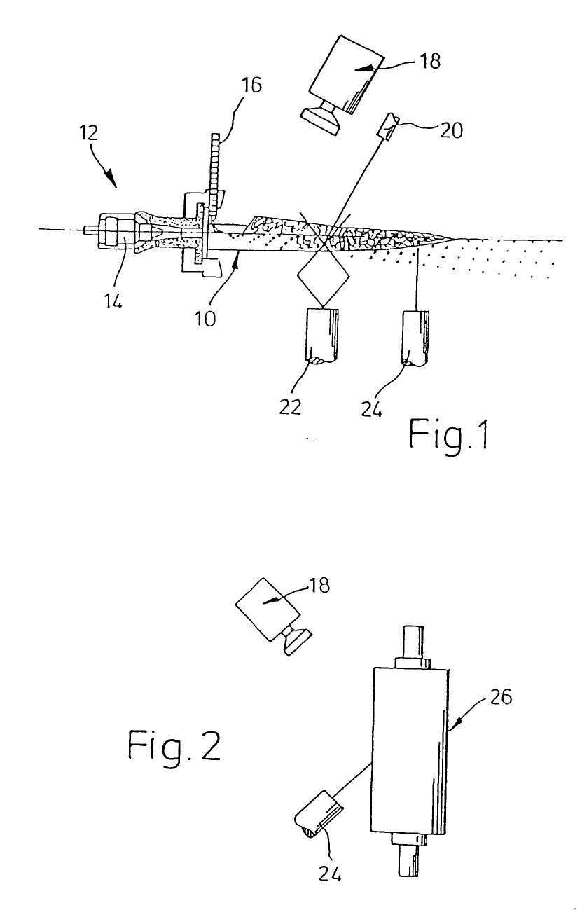

FIG. 1 shows an online control and monitoring system for a plasma installation,

FIG. 2 shows an installation for infrared thermography (ITG) and for high speed pyrometry (HSP—High Speed Pyrometry) in the thermal spraying operation,

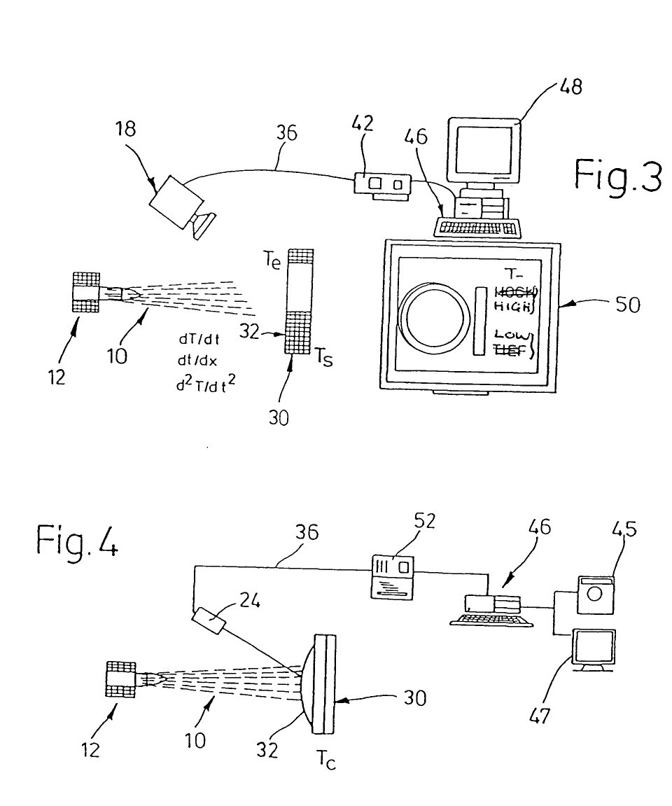

FIG. 3 shows a diagrammatic view relating to infrared thermography (ITG),

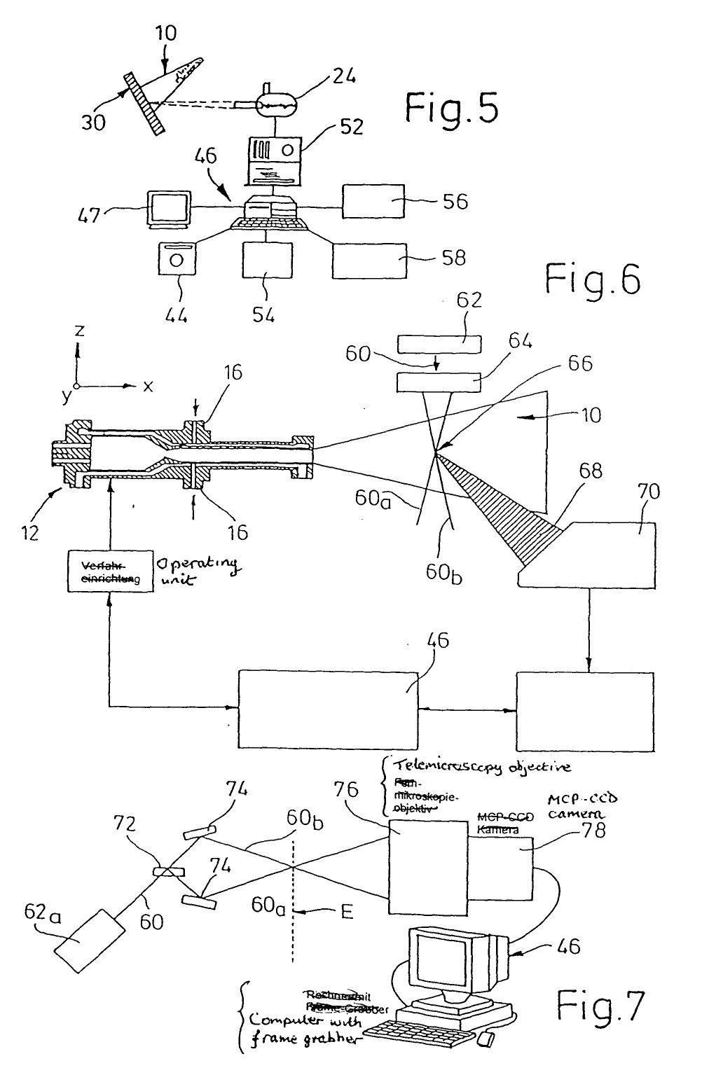

FIGS. 4 and 5 each show an installation for high speed pyrometry (HSP),

FIG. 6 shows an embodiment of a laser Doppler anemometer (LDA),

FIG. 7 shows a sketch relating to particle shape measurement in flight (PSI=Particle Shape Imaging),

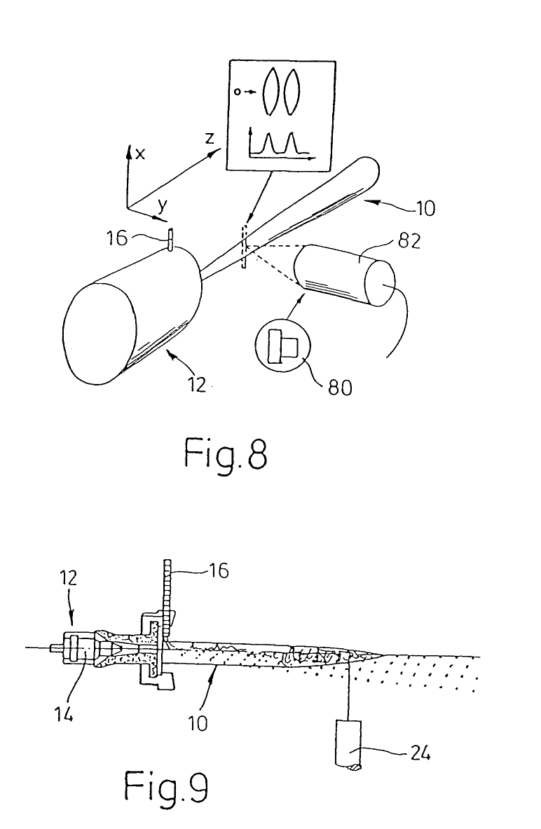

FIG. 8 shows particle temperature measurement in flight (PTM=Particle Temperature Measurement), and

FIG. 9 shows a sketch for measurement of particle temperature and speed.

All thermal spray processes such as autogenous flame spraying, high velocity flame spraying (HVOF), flame spraying in air (APS), so-called shroud plasma spraying (SPS), plasma spraying in vacuum (LPPS), high-power plasma spraying (HPPS), or autogenous or arc wire spraying can be used for applying wear and/or corrosion layers. Online monitoring and control is effected by means of a combination of various methods which make it possible to measure the temperature of the particle or the degree of melting, the particle size, the speed, the impingement thereof on the substrate and the heating of the layer and the substrate during the spraying procedure. The measurement signals are then passed to the computer of the control portion of the thermal spraying installation in order to be able to adapt the flame parameters and the output power to the measured values.

An online control and monitoring system shown in FIG. 1 for the flame or the spray jet 10 of a spray gun indicated at 12 or the like spray apparatus 12 with a powder feed 16 arranged in front of the burner nozzle 14 thereof has above the spray jet 10 an ITG camera 18—that is to say an infrared thermography camera—and a laser Doppler anemometer (LDA-detector) 20 for an LDA laser 22 which can be seen below the spray jet 10; it is possible to see beside same an HSP head 24—HSP=high speed pyrometry—which is connected to a coil-like measurement body 26.

As shown in FIG. 3, for the purposes of measuring the substrate temperature Tₛ and the coating temperature T_{c} by means of infrared thermography a substrate 30 which is to be provided with a coating 32 is disposed in the recording region of an ITG camera 18. Extending therefrom is a glass fiber cable 36 which leads to a video PC card indicated at 42-500 kHz. Connected to the card is a computer 46 with monitor 48 with which a temperature recording device 50 is associated here.

In FIG. 4 the HSP head 24 is connected for measuring the cooling rate or the coating temperature Tc by means of high speed pyrometry (HSP) of the coating 32 of the substrate 30. The head 24 is connected by way of an AD converter 52 to a computer 46 which has a memory element 44 and a monitor 48. A high speed pyrometer with an HSP head 24, an AD converter 52 and with a computer 46 which includes a user menu 54, a monitoring menu 56 and graphics software 58 can be seen in FIG. 5.

Optimisation of the spray parameters can be achieved with the process of so-called laser Doppler anemometry (LDA), at a low level of complication and expenditure in respect of time and work. In the case of the preferred dual-beam procedure the beam 60 of an argon ion laser indicated at 62 (λ=514.5 nm, P=150 mW) is broken down into two beam portions 60ₐ, 60_{b} of equal intensity by a transmission optical system 64. The two beam portions 60ₐ, 60_{b} are focussed into a stationary measurement volume 66. They there intersect at a defined angle in such a way that an interference pattern which is intensity-modulated in stripe form is produced. A particle of the spray jet 10 which flies through that stripe pattern generates a stray light signal 68 which is periodically variable in respect of time for a reception optical system with a photodetector 70. The modulation frequency of the stray light signal 68 is proportional to the speed component of the particle perpendicularly to the interference stripe system. The frequency of the LDA stray light signals is a measurement in respect of the local density of the particles in the plasma spray jet 10. By scanning of the jet it is possible to implement locationally resolved measurement of relevant particle parameters. It is possible to obtain therefrom results such as speed distribution, trajectories and residence times of the particles.

As individual determination of the size and the shape of a spray particle cannot be implemented with LDA, as shown in FIG. 7 particle shape imaging (PSI) is used, an imaging process for the locationally resolved determination of the size and shape of individual powder particles in plasma spray jets 10. The measurement principle is based on telemicroscopic imaging of the shadows of the particles, the measurement method has the advantages of a high level of light strength in comparison with stray light methods and at the same time a reduction to the desired image information. Similarly to the case with laser Doppler anemometry, the beam 60 of an Nd—YAG continuous wave laser 60ₐ (λ=532 nm, P=100 mW) is divided at a beam splitter 72 with mirrors 74 into two beam portions 60ₐ, 60_{b} of the same intensity, which are crossed by means of the mirrors 74 in the object plane E of the telemicroscopy objective of a telemicroscope 76. The use thereof makes it possible to maintain a safety distance of 600 mm in relation to the object being measured. With an imaging scale of 1:10 an optical resolution of 2.7 μm is still achieved. The image recording system comprises a CCD camera 78 with a Micro-Channel-Plate (MCP) image amplifier connected upstream thereof, with a minimum exposure time of 5 ns. The geometrical dimension of the 512×512 pixel CCD chip and the depth of focus range of the objective afford a measurement volume of 410×410×940 μm³.

For the situation where a particle in the measurement volume is exactly at the object plane E, partial shadows are generated by both beams 64, 64ₐ, which partial shadows are completely coincident upon imaging on the CCD chip and thus form a full shadow. In proportion to the distance of the particles from the object plane E the partial shadows in the image plane move away from each other and the full shadow region decreases. The position of a particle relative to the object plane E can be determined with that effect. The area and contour of the shadow image provide information about the size and shape of the particle. The LDA-interference stripe pattern which is also imaged affords the size scale. The minimum exposure time of the MCP-CCD camera of 5 ns gives a value of 500 m/s as the maximum particle speed at which the movement blur does not exceed the optical resolution capability.

In the case of the process of so-called in-flight particle diagnosis—in this respect attention is directed to FIG. 8—it is possible, irrespective of the spray process, to measure every second up to 200 individual particles at each point in a spray jet simultaneously in respect of their surface temperature, speed and size. An operating unit (not shown) additionally permits rastering of a plane perpendicularly to the spray jet 10 so that the distribution of the particles in the spray jet 10 can be precisely ascertained. The operation of determining temperature is effected by means of dual-wavelength pyrometry at 995±25 μm and 787±25 μm. In that situation the particles are treated as gray bodies so that there is no need to know the precise degree of emission, for temperature measurement. The system includes forming the image of a double-slit mask 80 measuring 25 μm×50 μm—at a measurement head 82—at a focal point at approximately 90 mm distance with a great depth of focus. That affords a measurement volume which in accordance with the graphic representation, in relation to FIG. 10, is characterised by two visible shadow regions and a shadow region therebetween. The measurement volume is about 170×250×2000 μm³. The natural radiation of individual particles which fly through that measurement volume is recorded by way of two IR detectors with two different wavelengths. The two measurement volume portions result in two temperature peaks. The spacing in respect of time of the two peaks is a measurement in respect of the speed of the particle. The principle corresponds to that of the light barrier arrangement.

That operating procedure makes it possible to determine particle surface temperatures of between 1350° C. and 4000° C. The measurable particle size substantially depends on the temperature of the particles. It is limited downwardly to about 10 μm and upwardly to about 300 μm and is determined by the absolute energy which is irradiated by the particle and which is proportional to the square of the diameter. The measurable speed range is 30 m/s-1500 m/s.

The view shown in FIG. 9 follows on from that in FIG. 1 and illustrates measurement of the particle temperature and speed by means of an HSP head 24.

The operating procedure will be described in greater detail by means of an example of use:

### EXAMPLE 1

A mold for producing zinc casting is to be provided with a layer which is to prevent material from baking on the mold.

An air plasma installation (APS) with an output power of 50 kW and equipped with online control was used on the inside of the mold.

The layer was intended to be of a layer thickness of between 0.1 and 0.5 mm, the spray material used was a powder of the following composition:

85% by weight of Fe₂O₃, and

15% by weight of Cr₂O₃.

1. A process for producing a corrosion- and wear-resistant layer on a substrate by flame spraying, in particular by plasma spraying in air or vacuum, high-power plasma spraying (HPPS) or shroud plasma spraying (SPS), of a material based on iron oxide, which consists of pure Fe₂O₃, and in which the application of the layer of the material is monitored by an online monitoring and control system.

2. A process as set forth in claim 1 characterised by an online-controlled wire flame spraying process or an online-controlled arc wire spraying process as the coating process.

3. A process as set forth in claim 1 or claim 2 characterised by online monitoring and control by means of an ITG camera (18) directed on to the spray jet (10), an LDA detector (20) with an LDA laser (22) and an HSP head (24) (FIG. 1).

4. A process as set forth in one of claims 1 through 3 characterised by online monitoring and control by detection of the particle speed in the spray flame.

5. A process as set forth in one of claims 1, 2 and 4 characterised by online monitoring and control by means of detection of the particle speed in the spray flame by a laser Doppler anemometer by means of a beam (60) emitted from a laser device (62) and broken down into two beam portions (60ₐ, 60_{b}) by a transmission optical system (64) (FIG. 6).

6. A process as set forth in claim 1 or claim 2 characterised by online monitoring and control by detecting the particle temperature in the spray flame by means of a high speed pyrometer.

7. A process as set forth in one of claims 1, 2 and 6 characterised by online monitoring and control in which the particle temperature in the spray flame is measured by means of infrared thermography (FIG. 3).

8. A process as set forth in claim 1 or claim 2 characterised by online monitoring and control in which the measured amount of gas is analysed.

9. A process as set forth in one of claims 1, 2 and 8 characterised by online monitoring and control in which a measured amount of plasma gas is analysed.

10. A process as set forth in claim 1 or claim 2 characterised by online monitoring and control in which a measured current-voltage characteristic is evaluated.

11. A process as set forth in claim 1 or claim 2 characterised by online monitoring and control in which an amount of powder fed to the spray flame is measured.

12. A process for producing a corrosion- and wear-resistant layer as set forth in one of claims 1 through 11 characterised in that the coating process used is an online-controlled plasma spray process which uses air as the plasma gas.

13. A process for producing a corrosion- and wear-resistant layer as set forth in one of claims 1 through 11 characterised in that the coating process used is an online-controlled water-stabilised plasma spray process.

14. A material for producing a corrosion- and wear-resistant layer on a substrate with the process as set forth in one of claims 1 through 13 characterised in that it comprises pure iron oxide Fe₂O₃.

15. A material for producing a corrosion- and wear-resistant layer on a substrate with the process as set forth in one of claims 1 through 13 characterised in that it comprises iron oxide Fe₂O₃ and at least one further metallic material.

16. A material for producing a corrosion- and wear-resistant layer on a substrate with the process as set forth in one of claims 1 through 13 characterised in that it comprises iron oxide Fe₂O₃ and at least one metallic compound.

17. A material for producing a corrosion- and wear-resistant layer on a substrate with the process as set forth in one of claims 1 through 13 characterised by an addition of carbide(s) or nitride(s) or silicide(s) or boride(s) or oxide(s).

18. A material for producing a corrosion- and wear-resistant layer on a substrate with the process as set forth in one of claims 1 through 13 characterised by the addition of a mixture of metals, intermetallic compounds, carbides, nitrides, suicides, borides and/or oxides.

19. A material for producing a corrosion- and wear-resistant layer on a substrate with the process as set forth in one of claims 1 through 13 or 15 characterised by iron oxide Fe₂O₃ and an addition of up to 50% by weight, preferably up to 40% by weight, of Cr, CrNi, or a ferritic steel.

20. A material for producing a corrosion- and wear-resistant layer on a substrate with the process as set forth in one of claims 1 through 13 or 17 characterised in that it comprises iron oxide Fe₂O₃ and carbides of W, Cr, Mo, Ta, Ti, V.

21. A material as set forth in claim 20 characterised in that it comprises iron oxide Fe₂O₃ with an addition of up to 30% by weight, preferably up to 20% by weight, of tungsten and/or chromium carbides.

22. A material for producing a corrosion- and wear-resistant layer on a substrate with the process as set forth in one of claims 1 through 13 or 17 characterised by a mixture of iron oxide Fe₂O₃ and chromium oxide.

23. A material as set forth in claim 22 characterised by a proportion of the chromium oxide of between 1 and 40% by weight, preferably between 5 and 30% by weight.

24. A material as set forth in one of claims 14 through 23 characterised by a grain size of the powder spray material of between 0.05 and 150 μm, preferably between 0.1 and 120 μm.

25. A material as set forth in one of claims 14 through 23 characterised by a filling wire in the form of spray material in wire form, the filling of which comprises magnetite and the sheath of which comprises an alloy.

26. A material as set forth in one of claims 14 through 25 characterised by a powder grain with good flow properties, the powder grain being produced from the material mixture in powder form by spray drying.

27. A material as set forth in claim 14 or claim 15 characterised by a powder grain which is produced from the material mixture in powder form by means of an agglomeration process and which is resistant to separation of the constituents of the mixture.
